(19) United States
(12) Patent Application Publication
(10) Pub. No.: US 2007/0280596 A1
(43) Pub. Date: Dec. 6, 2007

(54) Method and System for Writing Fiber Bragg Grating Having Apodized Spectrum on Optical Fibers

(76) Inventors: Rujie Hou, Waterloo (CA); Yunfei Zhao, Saint-Laurent (CA); Changzun Zhou, Pierrefonds (CA)

Correspondence Address: BROUILLETTE & PARTNERS, METCALFE TOWER, 1550 METCALFE STREET, SUITE 800, MONTREAL, QC, H3A-1X6, US

(21) Appl. No.: 11/752,380

(22) Filed: May 23, 2007

(30) Foreign Application Priority Data
May 23, 2006 (CA) 2548029

(51) Int. Cl. G02B 6/34

(52) U.S. Cl. 385/37

(57) ABSTRACT

This invention relates to a method and a system for writing fiber Bragg gratings (FBG) having apodized spectrum (“apodized FBG”) on optical fibers. An amplitude modulation mask is placed between a focusing cylindrical lens and the optical fiber. By reducing the distance between the amplitude mask and the fiber, the present invention can minimize diffraction effects that may be induced by long propagation distance of a laser beam passing through a small and/or narrow aperture in the amplitude mask. The method and system of the present invention can be applied to write FBG with apodized spectrum with small amplitude mask to achieve full width at half maximum (FWHM) bandwidth (BW) wider than 1.2 nm and to achieve side lobe suppression ratio (SLSR) as high as 30 dB. These method and system generally increase the laser power efficiency of the laser used in FBG inscription and optimizes the grating index modulation profile.

### CROSS-REFERENCE TO RELATED APPLICATIONS

The present patent application claims the benefits of priority of commonly assigned Canadian Patent Application No. 2,548,029, entitled “Method and System for Writing Fiber Bragg Grating Having Apodized Spectrum on Optical Fibers” and filed at the Canadian Patent Office on May 23, 2006.

### FIELD OF THE INVENTION

The present invention generally relates to methods and systems for writing fiber Bragg gratings on optical fibers. More specifically, the present invention relates to apodization method and system used for writing apodized fiber Bragg grating on optical fibers using amplitude masks.

### BACKGROUND OF THE INVENTION

Generally, when a fiber Bragg grating (hereinafter “FBG”) is written on an optical fiber with an uniform refractive index modulation along the grating region, the reflection spectrum of the FBG typically displays high side lobes on both side of the main reflected lobe. Moreover, the presence of cladding mode losses introduces unwanted attenuation at shorter wavelength with respect to main transmission attenuation peak. These undesirable features restrict the use of FBGs in many applications. For example, FBG based wavelength division multiplexing (hereinafter “WDM”) filters in telecommunication systems generally require side lobe suppression ratio (hereinafter “SLSR”) high enough to avoid cross talk between adjacent optical channels. FBG based WDM filters also require low cladding mode losses which tend to weaken signal in other channels. In sensing applications, high side lobes aside the main peak could be detected as weak sensor signal in sensing systems and hence corrupt the sensing information. Erbium doped fiber amplifier (hereinafter “EDFA”) pump laser stabilizer FBGs with high side lobe will induce unwanted lasing peaks and therefore increasing system noise.

Modulating the FBG refractive index with a pre-designed profile provides a solution for suppressing side lobes. This method is also referred to as apodization. Therefore, unlike uniform FBG, apodized grating has a modulated refractive index along the grating region in order to achieve desirable profiles such as Gaussian, cosine, Hamming, Blackman, etc.

Numerous methods and systems can be used to achieve an index profile apodization. For example, Mechin et al., in U.S. Pat. No. 6,574,395, provides a method for controlling the UV exposition time of the FBG by varying scanning beam velocity. Another method is proposed by Kersey et al. in U.S. Pat. No. 6,681,067 wherein the refractive index is selectively erased by heating and irradiation with a CO₂ laser. Another method consists of vibrating a UV beam by an acoustic-crystal frequency modification. However, the most widely used method for achieving apodized FBGs is by placing an amplitude mask with special designed profile on the propagating path of a UV laser beam between the laser and a cylindrical focusing lens.

Systems and methods to write FBGs are also know in the art. For example, Malo, in U.S. Pat. No. 6,911,659, teaches a system and a method to modify the refractive index of an optical fiber. However, the system and method of Malo include the use of a blocking mask which limits the kind on FBG that can be written since the blocking mask blocks a substantial amount of laser power.

Amplitude mask used for FBG apodization usually consists of two UV exploring windows. A first window is used for FBG AC index modulation while a second window is used for FBG DC index flattening compensation. The FBG DC index flattening compensation is generally necessary to minimize cladding mode losses. Using amplitude masks enables the writing of FBGs having high SLSR and low cladding loses in a single process. Therefore, using amplitude masks allows the writing of high performance FBGs.

A conventional setup 100 using the amplitude mask is shown in FIG. 1. As can be seen, the amplitude mask 110 of the setup 100 is mounted at a position before the cylindrical lens 120. In this configuration, any change in the position along the laser beam propagation path 150 will corresponds to the same apodization profile, as long as the amplitude mask 110 is kept before the cylindrical lens 120. This provides an easy way for modeling refractive index profile in optical fiber which also facilitates the amplitude mask design and the apodization applicability. However, one major disadvantage of this method is that the mask 110 blocks out a substantial portion of the UV laser beam and therefore decreases FBG writing efficiency. This is especially true in the case of amplitude masks having small aperture. This method thus makes it difficult to write strong FBG through amplitude mask having small aperture. In some cases, it is even impossible. Another disadvantage of this method comes from the apparition of distortions in the apodization profile. These distortions are caused by Fraunhofer diffraction due to the passage of the laser beam through the small aperture of the amplitude mask 110 and to the propagation of the laser beam over a relatively long distance to the optical fiber 140 located at the focal point of the cylindrical lens 120.

In conventional apodization method setup 100 as shown in FIG. 1, since changes in the position of the amplitude mask along the laser beam propagation path 150 do not affect the index modulation, each amplitude mask corresponds to one definite index modulation. In order to achieve different apodization profiles, one has to design and manufacture a different mask for each apodization profile. Moreover, since index modulation from a given amplitude mask may vary according to different laser beam conditions, it may be necessary to have multiple amplitude mask for the same index modulation. Therefore, developing an amplitude mask for a given index modulation very often results in an iterative procedure comprising the steps of designing an amplitude mask, correcting it, redesigning it, re-correcting it, so on and so forth. Not only is this procedure increasing the cost, it is also decreasing the flexibility and the time-efficiency of designing new index modulating amplitude masks. This hinders scientific research and engineering development for new FBGs.

There is therefore a need for a new system and a new method for writing apodized FBGs which obviate the aforementioned disadvantages.

### SUMMARY OF THE INVENTION

An object of the present invention is to provide an apodization method and system for modulating the laser power profile through an amplitude mask when writing FBG with a laser.

Another object of the present invention is to provide an apodization method and system wherein the amplitude mask is located between the cylindrical lens and the optical fiber.

Yet another aspect of the present invention is to provide an apodization method and system wherein the position of the amplitude mask can be adjusted between the cylindrical lens and the optical fiber.

Accordingly, the present invention provides a method and a system for writing FBGs on optical fiber, such FBGs having a refractive index which is modulated along the grating area in order to provide apodized spectra.

The setup of the invention generally comprises a UV laser source for inducing refractive index changes in the optical fiber material. Numerous wavelengths can be used, such as, but without being limitative, 244 and 248 nanometres. Understandably, the wavelength can be chosen according to the application.

The setup on the invention further comprises a cylindrical lens for focusing the UV laser beam. Generally located at or near the focal point of the cylindrical lens is the optical fiber unto which is written the actual FBG.

According to the present invention, the amplitude mask used to modulate the refractive index of the grating is located along the focused beam of UV light between the cylindrical lens and the optical fiber. Preferably, the amplitude mask is placed near to the focal point of the cylindrical lens. Due to short distance between amplitude mask and the optical fiber, this setup can avoid undesirable Fraunhofer diffraction and/or Fresnel diffraction induced by the propagation over a long distance of a beam of light passing through a small aperture or narrow slit in the amplitude masks.

Moreover, since the amplitude mask is positioned between the cylindrical lens and the optical fiber, the amplitude mask blocks a smaller portion of UV light as compared to prior art settings (e.g. U.S. Pat. No. 6,911,659). Therefore, this novel setup allows for the UV writing of strong FBGs with amplitude mask having a small aperture or narrow strong apodization amplitude mask with high efficiency.

Another important aspect of the present invention is that since the amplitude mask is disposed along the focused beam of light between the cylindrical lens and the optical fiber, different position of the amplitude mask will define different index modulation profile in the FBG. Therefore, by tuning or adjusting the distance from the amplitude mask to fiber along the focused laser beam, it is possible to continuously change the apodization profile. This further enables the optimization of the grating index modulation with a single amplitude mask.

If and/or when necessary, the setup of the present invention can further be provided with a phase mask, disposed substantially near the optical fiber. The phase mask is used to diffract the focused beam of light into two directions toward the fiber. The diffracted beam of light generates an interference pattern that covers the grating area of the fiber. The interference pattern comprises alternating regions of high intensity and low intensities. It is the high intensity regions that create changes in the refractive index of the fiber.

Understandably, other and further objects and advantages of the present invention will be obvious upon an understanding of the illustrative embodiments about to be described or will be indicated in the appended claims, and various advantages not referred to herein will occur to one skilled in the art upon employment of the invention in practice.

### BRIEF DESCRIPTION OF THE DRAWINGS

The present invention shall become better understood by reference to the following detailed description and considered in connection with the accompanying drawings wherein:

FIG. 1 is a schematic illustration of a setup used for writing FBG having modulated refractive index using an amplitude mask according to the method and system of the prior art.

FIG. 2 is a schematic illustration of a setup used for writing FBG having modulated refractive index using an amplitude mask according to the method and system of the present invention.

### DETAILED DESCRIPTION OF THE PREFERRED EMBODIMENT

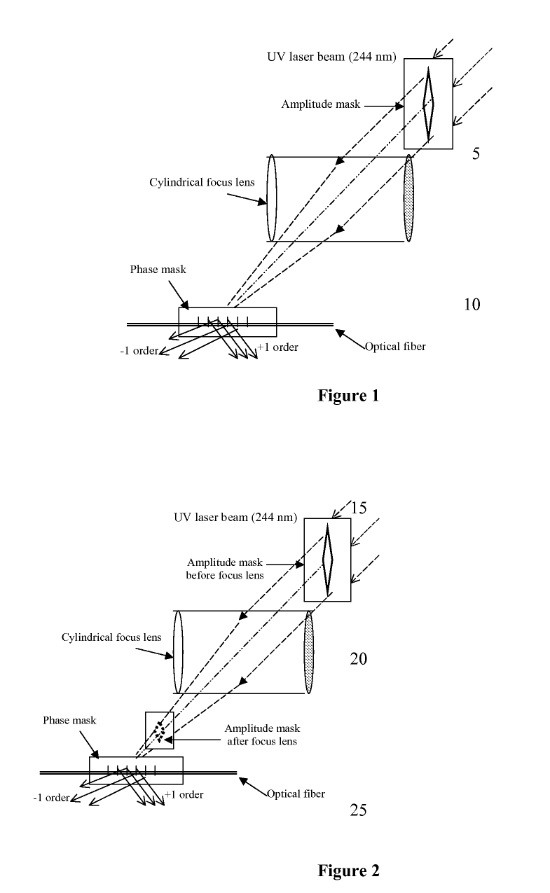

Referring to FIG. 2, the setup 200 used in the method and system of the present invention is shown. As can be noted, FIG. 2 comprises two amplitude masks. A first “real” amplitude mask 270, is positioned between the cylindrical lens 220 and the optical fiber 240 as per the invention. The second amplitude mask 210, shown in phantom lines, is the equivalent, at least in ray optic, of the first amplitude mask 270 should the amplitude mask 270 be placed before the cylindrical lens 220 (as in the prior system of FIG. 1).

As stated above, in ray optic, both amplitude masks 210 and 270 are equivalent. However, in wave optic, both amplitude masks 210 and 270 are not equivalent. In other words, the apodization profile defined by the amplitude mask 210 would be different from the apodization profile defined by the amplitude mask 270. This difference is one of the bases of the present invention.

As explained above, contrary to conventional FBG apodization method setup (see FIG. 1), in this invention, the amplitude mask 270 is placed along the focused laser beam propagation path 260, between the cylindrical lens 220 and the focus point where the optical fiber 240 is mounted with means known in the art. According to the laws of ray optic, the amplitude mask 270 has a substantially equivalent amplitude mask 210 in the laser beam propagation path 250 before the cylindrical lens 220. The converse is also true. Therefore, amplitude mask 210 positioned before the cylindrical lens 220 and along the laser beam propagating path 250 has a substantially equivalent amplitude mask 270 along the focused beam propagating path 260 and located between the cylindrical lens 220 and the optical fiber 240. According to the laws of ray optic, both masks 210 and 270 are mutual images of each other. Therefore, still according to ray optic, these equivalent amplitude masks should provide the same apodization profile on the optical fiber 240. From the optical fiber 240 position point of view and according to wave optic, the apodization profiles provided by both masks 210 and 270 are different and even irreversible.

Referring now to FIG. 1, we can see a prior art setup 100 for apodization method and system. In this setup, the amplitude mask 110 is placed before the cylindrical lens 120 and along the laser beam propagation path 150. In setup 100, the amplitude mask 110 can provide only one power modulation profile on the optical fiber 140 even though it has many substantially equivalent masks along the focus beam propagation path 160.

In optimized focus condition, the total laser power that reaches the optical fiber 140 is constant. In the case of an amplitude mask 110 having a small aperture, since most of the laser power is blocked out by the amplitude mask 110, this limits the strength of the grating writing when apodization is used. Understandably, the laser power blocked by the amplitude mask 110 cannot be used to write the grating.

Moreover, after having passed through the small aperture of the amplitude mask 110, the laser still has a relatively long distance to travel before reaching the optical fiber 140. Laser beam which travels over long distance after going through a small aperture induces distortion in the apodization profile because of Fraunhofer diffraction. Similarly, strong apodization with narrow-high amplitude mask induces distortion in the apodization profile because of Fresnel diffraction which are caused when the laser beam travels a long distance after going through a slit-like aperture.

However, as shown in FIG. 2 and as explained above, if an amplitude mask 270 is placed along the focus laser beam propagation path 260 between the cylindrical lens 220 and the optical fiber 240, the amplitude mask 270 has an equivalent mask 210 before the cylindrical lens 220. Moreover, by displacing the amplitude mask 270 along the focus laser beam propagating path 260 (see arrow 290), the amplitude mask 270 can define a series of different equivalent amplitude masks 210 depending the mask 270 position. These equivalent masks will have the same width but different height and therefore, different apodization profile. Thus, only by varying the position of a single amplitude mask 270, it is possible to create a plurality of apodization profile.

Also, by placing the amplitude mask 270 along the focused laser beam propagation path 260, the laser power inherently blocked by the mask 270 is significantly lower than if the mask 270 was equivalently placed before the cylindrical lens 220. By blocking less laser power, the amplitude mask 270 allows for the writing of stronger FBG with the apodization method and system.

Furthermore, by placing the amplitude mask 270 nearer the optical fiber 240, the distance traveled by the laser beam after going through a small aperture or a narrow slit-like opening is substantially reduced. This results is a tremendous reduction of the distortions in the apodization profile caused by Fraunhofer diffraction and/or Fresnel diffraction.

The skilled addressee will understood that the setup 200 of the present invention can obviously further comprises a phase mask 230, known in the art, placed substantially near the optical fiber 240 as in the prior art setup 100 (see FIG. 1). Phase mask 230 is used for creating an interference pattern on the grating writing area of the optical fiber 240.

Although preferred embodiments of the invention have been described in detail herein and illustrated in the accompanying figures, it is to be understood that the invention is not limited to these precise embodiments and that various changes and modifications may be effected therein without departing from the scope or spirit of the present invention.

1. A system for writing a grating having a substantially apodized spectrum on an optical fiber having a refractive index, said system comprising:
a. a laser light source generating a laser light beam;
b. a cylindrical lens, disposed substantially transversally of said laser light beam, for focusing said laser light beam into a focused light beam and toward a focal point;
c. an amplitude mask disposed substantially transversally of said focused light beam, said amplitude mask having an aperture for creating a narrow focused light beam;
wherein said optical fiber is disposed substantially transversally of said narrow focused light beam and substantially near or at said focal point of said cylindrical lens whereby said narrow focused light beam illuminates a narrow portion of said optical fiber and changes said refractive index of said narrow portion of said fiber.

2. A system as claimed in claim 1, wherein said laser light source is an ultra-violet laser light source.

3. A system as claimed in claim 2, wherein the wavelength of said ultra-violet laser light source is 244 nanometres or 248 nanometers.

4. A system as claimed in claim 1, wherein said system further comprises a phase mask disposed substantially transversally of said narrow focused light beam between said amplitude mask and said optical fiber.

5. A system as claimed in claim 1, wherein the position of said amplitude mask along said focused light beam can be changed.

6. A system as claimed in claim 4, wherein the position of said amplitude mask along said focused light beam can be changed.

7. A system as claimed in claim 1, wherein said aperture is a narrow aperture.

8. A system as claimed in claim 1, wherein said aperture is a slit-shaped aperture.

9. A method for writing a grating having a substantially apodized spectrum on an optical fiber having a refractive index, said method comprising the steps of:
a. directing a laser light beam onto a cylindrical lens disposed substantially transversally of said laser light beam;
b. focusing said laser light beam with said cylindrical lens into a focused light beam and toward a focal point;
c. directing said focused light beam onto an amplitude mask disposed substantially transversally of said focused light beam, said amplitude mask having an aperture for creating a narrow focused light beam;
d. directing said narrow focused light beam onto said optical fiber, said optical fiber being disposed substantially transversally of said narrow focused light beam and substantially near or at said focal point of said cylindrical lens whereby said narrow focused light beam illuminates a narrow portion of said optical fiber and changes said refractive index of said narrow portion of said fiber.

10. A method as claimed in claim 9, wherein said laser light beam is an ultra-violet laser light beam.

11. A method as claimed in claim 10, wherein the wavelength of said ultra-violet laser light beam is 244 nanometres or 248 nanometers.

12. A method as claimed in claim 9, wherein step d) is replaced by the steps of:
d. directing said narrow focused light beam onto a phase mask disposed substantially transversally of said narrow focused light beam whereby said phase mask creates diffracted light beams;
e. directing said diffracted light beams onto said optical fiber, said optical fiber being disposed substantially transversally of said diffracted light beams and substantially near or at said focal point of said cylindrical lens whereby said diffracted light beams illuminate a portion of said optical fiber in an interference pattern having alternating regions of low and high light intensity and whereby said regions of high intensity change said refractive index of said regions.

13. A method as claimed in claim 9, further comprising the step of adjusting the position of said amplitude mask along said focused light beam.

14. A method as claimed in claim 9, wherein said aperture is a narrow aperture.

15. A method as claimed in claim 9, wherein said aperture is a slit-shaped aperture.

16. A system for writing a grating having a substantially apodized spectrum on an optical fiber having a refractive index, said system comprising:
a. a laser light source generating a laser light beam;
b. a cylindrical lens, disposed substantially transversally of said laser light beam, for focusing said laser light beam into a focused light beam and toward a focal point;
c. an amplitude mask disposed substantially transversally of said focused light beam, said amplitude mask having an aperture for creating a narrow focused light beam;
d. a phase mask disposed substantially transversally of said narrow focused light beam, said phase mask creating diffracted light beams;
wherein said optical fiber is disposed substantially transversally of said diffracted light beams and substantially near or at said focal point of said cylindrical lens whereby said diffracted light beams illuminate a portion of said optical fiber in an interference pattern having alternating regions of low and high light intensity and
whereby said regions of high intensity change said refractive index of said regions.

17. A system as claimed in claim 16, wherein said laser light source is an ultra-violet laser light source.

18. A system as claimed in claim 17, wherein the wavelength of said ultra-violet laser light source is 244 nanometres or 248 nanometers.

19. A system as claimed in claim 16, wherein the position of said amplitude mask along said focused light beam can be changed.

20. A system as claimed in claim 16, wherein said aperture is a narrow aperture.

21. A system as claimed in claim 16, wherein said aperture is a slit-shaped aperture.
